(19) United States
(12) Patent Application Publication
(10) Pub. No.: US 2015/0341328 A1
(43) Pub. Date: Nov. 26, 2015

(54) Enhanced Multi-Level Authentication For Network Service Delivery

(71) Applicant: ALCATEL-LUCENT CANADA INC., Ottawa (CA)

(72) Inventors: Ramaswamy Subramanian, Ottawa (CA); Tiru K. Sheth, Ottawa (CA)

(73) Assignee: ALCATEL-LUCENT CANADA INC., Ottawa (CA)

(21) Appl. No.: 14/282,657

(22) Filed: May 20, 2014

(51) Int. Cl. H04L 29/06

(52) U.S. Cl. CPC H04L 63/08

(57) ABSTRACT

One embodiment of an apparatus, e.g. a RADIUS server, includes a processor and a processor-readable storage medium. The memory contains instructions that when executed configure the processor to 1) authenticate a user for access to network services based on user-specific account credentials; and 2) authenticate the user for access to network services based on at least one parameter specific to at least one physical network component used to provide the network services to the user.

### TECHNICAL FIELD

The disclosure relates generally to the field of communications, including but not limited to delivery of networked services via the Internet.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

A network service provider may establish certain authentication credentials for access to a subscriber account. Such credentials are intended to, e.g., limit access to network services to only the subscriber. However, there may be little the provider can do to prevent subscriber credentials from being used by non-subscribers, either by sharing of subscriber credentials or successful guessing of credentials by a non-subscriber. Providing services to non-subscribers loads provider resources, which may degrade the quality of services provided to legitimate subscribers, and may reduce the income of the service provider in the case that a person who would otherwise purchase services need not do so.

### SUMMARY

One embodiment provides an apparatus, e.g. a remote authentication dial-in user service (e.g. RADIUS) server, that includes a processor and a non-transitory processor-readable storage medium, e.g. a memory, coupled to the processor. The storage medium contains instructions that when executed configure the processor to 1) authenticate a subscriber for access to network services based on subscriber-specific account credentials; and 2) authenticate the subscriber for access to network services based on at least one parameter specific to at least one physical network component used to provide the network services to the subscriber.

Another embodiment provides a method, e.g. of operating a RADIUS server. The method includes 1) authenticating a subscriber for access to network services based on subscriber-specific account credentials, and 2) authenticating the subscriber for access to network services based on at least one parameter specific to at least one physical network component used to provide the network services to the subscriber.

In any embodiment of the method or apparatus the at least one parameter may include a network access server (NAS) identifier (ID) used to deliver the network services to the subscriber. In any embodiment the at least one parameter may include an NAS internet protocol (IP) address used to deliver the network services to the subscriber. In any embodiment the at least one parameter includes a description of an NAS port used to deliver the network services to the subscriber. In any embodiment the at least one parameter may include a digital subscriber lane access multiplexer (DSLAM) descriptor and/or a DSLAM port descriptor. In any embodiment the network services may include at least one bandwidth-intensive service. The at least one bandwidth-intensive service may include at least two of streaming television, broadband Internet access and IP telephone.

Another embodiment provides an apparatus, e.g. a network access server that includes a processor and a non-transitory processor-readable storage medium readably coupled to the processor. The processor is configured to read the instructions, thereby being configured the processor to communicate via a network to provide, via the network, at least one parameter specific to at least one physical network component used to provide network services to a network service subscriber. The processor is further configured by the instructions to receive, via the network, an indication of authentication of the subscriber based on the at least one parameter.

In any embodiment of apparatus, the instructions may further configure the processor to provide, via the network, subscriber account credentials for authentication of a network service subscriber, and to receive, via the network, an indication of acceptance of the subscriber account credentials. In such embodiments the acceptance of the subscriber account credentials, and authentication of the subscriber based on the at least one parameter, are both required to provide the network services to the subscriber.

In any embodiment of the apparatus the at least one parameter may includes one or more of the parameters selected from the group consisting of 1) an NAS ID used to deliver the network services to the subscriber, 2) an NAS IP address used to deliver the network services to the subscriber, 3) a description of an NAS port used to deliver the network services to the subscriber, 4) a DSLAM descriptor; and 5) a DSLAM port descriptor.

Some embodiments also include a RADIUS server and a DSLAM configured to communication with the processor. The RADIUS server is being further configured to receive the at least one parameter and to provide the indication of authentication.

In some embodiments of the apparatus the network services include a plurality of bandwidth-intensive services. The bandwidth-intensive services may include at least two of streaming television, broadband Internet access and IP telephone.

### DETAILED DESCRIPTION

Embodiments presented herein describe some improved apparatus, systems and methods that may be useful to provide improved subscriber authentication for network services to a subscriber to the services. Such embodiments provide a mechanism for the network service provider to reduce instances of valid network service subscriber credentials being used from physical locations other than those locations properly associated with the subscriber credentials the service providing subscriber in triple-play service networks. Such improvements may provide benefits such as, e.g., lower loss of revenue and lower resource demands for subscriber identification.

Embodiments of the invention will be described below in the context of illustrative systems and network architectures. However, it is to be appreciated that embodiments are not limited to any particular communication protocols or network architectures. Rather, embodiments are applicable to any suitable communication environment where it would be desirable to provide improved authentication of subscribers to a subscription service.

As will be illustratively referred to herein, the following acronyms have the following meanings:

PPP: Point-to-Point Protocol;

RADIUS: Remote Authentication Dial-In User Service;

PAP: Password Authentication Protocol;

CHAP: Challenge Handshake Authentication Protocol;

VSA: Vendor-Specific Attributes;

DSL: Digital Subscriber Line;

CPE: Customer Premises Equipment

NAS: Network Access Server;

BRAS: Broadband Remote Access Server;

IP: Internet Protocol; and

DSLAM: Digital Subscriber Line Access Multiplexer.

In some conventional systems, service providers use PPP to provide bandwidth intensive services. In the context of the description and the claims, “bandwidth intensive” is defined as having a bit rate of at least about 5 Mbit/s. One example of such service is so-called “triple-play” service. As appreciated by those skilled in the pertinent art, triple-play service is a term that is inclusive of the provisioning, over a single broadband connection, of at least two bandwidth-intensive services, e.g. broadband Internet access, television, and IP telephone. Systems that provide these or similar services may, in some cases, use PAP or CHAP to authenticate a service subscriber. As described below, conventional implementations of these authentication protocols may be deficient in that credentials associated with a single service subscriber may be used from multiple locations and/or multiple users when the service provider's intent is to provide service to a single location and/or user access at a time.

In an embodiment of the invention a networked computing system includes a CPE, e.g. a residential gateway such as a DSL modem or an optical modem, connected to one or more user devices, e.g. a computer, IP telephone, television, or other networkable device. In addition to the CPE, the system includes a DSLAM, a BRAS/NAS and a RADIUS server. These devices are interconnected via a network such as the Internet. The DSLAM may communicate with the CPE and the BRAS/NAS using PPP, while the BRAS/NAS and the RADIUS server may communicate via RADIUS communication protocol. The BRAS/NAS has associated attributes, e.g. NAS identifier (ID), NAS IP address, and NAS port. The DSLAM also has associated attributes, e.g. Agent_Circuit_ID. These attributes are examples of parameters specific to at least one physical network component used to provide network services by the server to the subscriber. These parameters are examples of some parameters used to describe aspects of the operational configuration of the BRAS/NAS. Such parameters may be used to determine the location of the subscriber with sufficient specificity that a particular subscriber would be effectively prevented from operating more than a single instance of the CPE to obtain services from the RADIUS server. The attributes may also include a VSA such as an identity of the DSLAM. An identity may include, e.g. a model number, serial number or similar attribute.

A user of a device may seek authentication by the RADIUS server for access to services, e.g. television and/or broadband access. Such services, e.g. bandwidth intensive or triple-play services, may be provided by an operator of the RADIUS server. In conventional operation the networked devices may implement a PAP instruction protocol or a CHAP protocol during authenticate of one of the user devices.

In conventional operation, the RADIUS server may use only a user name and password to authenticate a user of a device. In contrast, embodiments of this disclosure use additional authentication criteria that describe aspects of at least one physical network component used to provide the network services to the subscriber. These criteria may be used by the service provider to prevent the distribution of network services to those other than the subscriber. Some embodiments of the invention include a PAP, and some embodiments include a CHAP. PAP-based embodiments and CHAP-based embodiments are addressed in turn.

When implemented in the PAP protocol, in a first step the CPE sends a PAP_Authenticate_Request to the BRAS/NAS via the DSLAM. This request may be conventional, and may include a session-id, a user-name and a password. In a second step the BRAS/NAS sends an Access_Request message to the RADIUS server. This request may also include the user-name and password provided by the CPE. The Access_Request message also includes at least one parameter specific to at least one physical network component used to provide the network services to the subscriber. For example, the Access_Request message may include one or more of following attributes/VSAs that describe the BRAS/NAS:

1. NAS Identifier. This attribute is a RADIUS attribute that a RADIUS client, e.g. the BRAS/NAS, uses to identify itself to the RADIUS server. The NAS Identifier can be used instead of an IP address to identify the client. The NAS identifier may include one or more octets and is typically unique in the scope of the RADIUS server. The NAS identifier may be, in some embodiments, a fully qualified domain name (FQDN) of the RADIUS client.

2. NAS IP Address.

3. NAS Port.

4. An identity of the DSLAM, e.g. a serial number.

5. The port of the DSLAM to which the CPE is coupled. This port may be conveyed by the DSLAM via a VSA such as Agent-Circuit-Id.

In a third step the RADIUS server returns an Access_Accept message to the BRAS/NAS in the event that the RADIUS server authenticates the subscriber by the account credentials and the at least one parameter. The Access_Accept message may include, e.g. a subscriber line access (SLA) profile, subscriber ID and Subscriber Profile based on the subscriber subscriptions. If the server fails to authenticate the subscriber then the server returns an Access_Reject message to the BRAS/NAS, and the purported subscriber is denied access to network services. In the event that the server returns an Access_Accept message, the BRAS/NAS sends, in a fourth step, a PAP_Authenticate_Ack message to the CPE to provide access to network services to the subscriber. This message may be otherwise conventional and convey a session-id to the CPE.

When various embodiments operating under the CHAP protocol, a first step includes the BRAS/NAS first generating a challenge. In a second step the BRAS/NAS sends, via a CHAP_Challenge message, the challenge and a session ID to the CPE. In a third step CPE in a CHAP_Response message returns to the BRAS/NAS a user name, e.g. the user name of the purported subscriber, a response to the challenge, and a session-id. In a fourth step the BRAS/NAS sends an Access_Request message to the RADIUS server, the request including the username, a CHAP request and the challenge. This response also includes at least one parameter specific to at least one physical network component used to provide the network services to the subscriber, as described for the second step operating under the PAP. In a fifth step the RADIUS server returns an Access_Accept message to the BRAS/NAS, which then in a sixth step sends a CHAP_Success message to the CPE in the event that the server authenticates the subscriber.

In each of the PAP and CHAP protocols, the subscriber is identified by the username and password or challenge response. This authentication information is configured on the RADIUS server as well as the CPE. The RADIUS server is maintained by a service provider. In conventional operation the RADIUS server authenticates the subscriber using only the username and password, and provides network services, e.g. triple play services, to the subscriber with no additional authentication. As a result, some subscribers may exploit this relatively unsophisticated authentication method to obtain network access in multiple locations by configuring the same authentication credentials on multiple residential gateways, e.g. other instances of the CPE. As a result, the service provider may suffer e.g. lost revenue, and may be forced to employ additional computational resources to detect such abusive behavior. Notably, in conventional operation of the server the service provider does not use additional authentication criteria to deny access to the multiple instances of the CPE configured to present the account credentials of the subscriber.

Embodiments of a system that may implement the previously described CPR, DSLAM, BRAS/NAS and RADIUS server may include a processor, a memory and I/O. The processor may be any single device or collection of devices configured to execute instructions of an instruction program. Thus, the term “processor” is inclusive of a microcomputer, central processing unit, microcontroller, state machine and digital signal processor. The memory may be any single device or collection of devices and is an example of a non-transitory processor-readable storage medium that is configured to store program instructions in a nonvolatile, or nontransitory nature. Thus, the term “memory” is inclusive of read-only memory (ROM), random access memory (RAM), compact disk (CD) ROM, flash memory and magnetic information storage media. The I/O may be any single device or collection of devices configured to provide an electrical and/or logical interface between the processor and the network linking the CPE, the DSLAM, the BRAS/NAS and the RADIUS server.

The following describes a method that may be implemented by the RADIUS server in various embodiments. For example, the memory contained by the RADIUS server may include instructions, e.g. a program, that configure the RADIUS server processor to operate to implement the following method. The following description refers to the RADIUS server and the BRAS/NAS in an example embodiment. Those skilled in the pertinent art will recognize that the method may be implemented by any similar devices that may be formally referred to by other names, but are configured to implement similar functionality in a networked system to provide subscriber services.

In a first step the RADIUS server determines if the user account credentials define access to a valid subscriber account. A valid account may be an account that refers to, e.g., a current subscriber with a paid-up account, or a guest subscriber with a trial account. If the account credentials do not define a valid account, the method advances to a denial step in which the purported subscriber is denied access to subscription services. If the account credentials do define a valid account, then the method advances to a second step.

In the second step the NAS IP address of the BRAS/NAS is examined for validity. A valid NAS IP address may be an address that is mapped to the subscriber defined by the user account credentials. For example, when the network service account is provisioned, the NAS IP address of the BRAS/NAS of the physical layer that provide the network services to the subscriber may be recorded in a database record associated with that subscriber. If the NAS IP address being examined fails to match the stored NAS IP address, then the address may be considered invalid, and the method advances to the denial step, thus denying subscriber services to the purported subscriber. If instead the NAS IP address being examined successfully matches the NAS IP address associated with the account credentials previously received, then the method advances to a third step.

In the third step the NAS ID of the BRAS/NAS is examined for validity. A valid NAS ID may be an NAS ID that is mapped to the subscriber defined by the user account credentials. As described for the NAS IP address, the NAS ID of the BRAS/NAS may be stored when the subscriber account is provisioned. If the NAS ID being examined fails to match the stored NAS ID, then the ID may be considered invalid, and the method advances to the denial step, again denying subscriber services to the purported subscriber. If instead the NAS ID being examined successfully matches the NAS ID associated with the account credentials previously received, then the method advances to a fourth step.

In the fourth step the NAS port of the BRAS/NAS is examined for validity. A valid NAS port may be an NAS port that is mapped to the subscriber defined by the user account credentials. Similar to the previous NAS parameters, the NAS port of the BRAS/NAS may be stored when the subscriber account is provisioned. If the NAS port being examined fails to match the stored NAS port, then the ID may be considered invalid, and the method advances to the denial step, denying subscriber services to the purported subscriber. If instead the NAS port being examined successfully matches the NAS port associated with the account credentials previously received, then the method advances to a fifth step.

In the fifth step an identity of the DSLAM is examined for validity. The DSLAM may have a name logically associated therewith, which may again be recorded during subscriber account provisioning. If the DSLAM identity being examined fails to match the stored DSLAM identity, then the DSLAM identity may be considered invalid, and the method advances to the denial step, denying subscriber services to the purported subscriber. If instead the DSLAM identity being examined successfully matches the DSLAM identity associated with the account credentials previously received, then the method advances to a sixth step.

In the sixth step a descriptor of the DSLAM port to which the subscriber is connected is examined for validity. A valid DSLAM port descriptor may be a DSLAM port descriptor that is mapped to the subscriber defined by the user account credentials. Similar to the previous parameters, the DSLAM port descriptor of the DSLAM may be stored when the subscriber account is provisioned. If the DSLAM port descriptor being examined fails to match the stored DSLAM port descriptor, then the port descriptor may be considered invalid, and the method advances to the denial step, denying subscriber services to the purported subscriber. If instead the DSLAM port descriptor being examined successfully matches the DSLAM port descriptor associated with the account credentials previously received, then the method advances to an authentication step in which the purported subscriber is authenticated as a valid subscriber. The method may then terminate, and services may be provided to the valid subscriber.

The method may be implemented as, e.g. as rule table accessible to the processor of the RADIUS server. The rule table may be stored in nontransitory memory, and may also be transferred to a working, e.g. volatile memory accessible to the processor. Furthermore, while the illustrative embodiment of the method is described as examining each of the attributes NAS IP address, NAS ID, NAS port, DSLAM descriptor and DSLAM port, in other embodiments the purported subscriber may be authorized by using fewer of these parameters, by using one or more of these parameters in combination with one or more other parameters specific to at least one physical network component used to provide the network services to the subscriber, or by using one or more such other parameters and none of the specific parameters in the described embodiment of the RADIUS server method.

The description and drawings merely illustrate the principles of the invention. It will thus be appreciated that those skilled in the art will be able to devise various arrangements that, although not explicitly described herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. An apparatus, comprising:
a processor; and
a non-transitory processor-readable storage medium coupled to the processor and containing instructions that when executed configure the processor to:
authenticate a user for access to network services based on user-specific account credentials; and
authenticate the user for access to network services based on at least one parameter specific to at least one physical network component used to provide the network services to the user.

2. The invention recited in claim 1, wherein the at least one parameter includes a network access server (NAS) identifier (ID) used to deliver the network services to the user.

3. The invention recited in claim 1, wherein the at least one parameter includes a network access server (NAS) internet protocol (IP) address used to deliver the network services to the user.

4. The invention recited in claim 1, wherein the at least one parameter includes a description of a network access server (NAS) port used to deliver the network services to the user.

5. The invention recited in claim 1, wherein the at least one hardware-specific parameter includes a digital subscriber lane access multiplexer (DSLAM) descriptor and/or a DSLAM port descriptor.

6. The invention recited in claim 1, wherein the network services include at least one bandwidth-intensive service.

7. The invention recited in claim 6, wherein the at least one bandwidth-intensive service includes at least two of streaming television, broadband Internet access and IP telephone.

8. An apparatus, comprising:
a non-transitory processor-readable storage medium containing instructions; and
a processor operable to read the instructions, wherein the instructions configure the processor to communicate via a network to:
provide, via the network, at least one parameter specific to at least one physical network component used to provide network services to a network service subscriber; and
receive, via the network, an indication of authentication of the subscriber based on the at least one parameter.

9. The invention of claim 8, wherein the instructions further configure the processor to:
provide, via the network, user account credentials for authentication of a network service subscriber; and
receive, via the network, an indication of acceptance of the user account credentials,
wherein the acceptance of the user account credentials, and authentication of the subscriber based on the at least one parameter, are both required to provide the network services to the subscriber.

10. The invention recited in claim 8, wherein the at least one parameter includes one or more of the parameters selected from the group consisting of:
a network access server (NAS) identifier (ID) used to deliver the network services to the user;
a network access server (NAS) internet protocol (IP) address used to deliver the network services to the user;
a description of a network access server (NAS) port used to deliver the network services to the user;
a digital subscriber lane access multiplexer (DSLAM) descriptor; and
a DSLAM port descriptor.

11. The invention recited in claim 8, further comprising a remote authentication dial-in user service (RADIUS) server and a digital subscriber line access multiplexer (DSLAM) configured to communication with the processor, the RADIUS server being further configured to receive the at least one parameter and to provide the indication of authentication.

12. The invention recited in claim 8, wherein the network services includes at least one bandwidth-intensive service.

13. The invention recited in claim 12, wherein the at least one bandwidth-intensive service includes at least two of streaming television, broadband Internet access and IP telephone.

14. A method of operating a RADIUS server, comprising:
authenticating a user for access to network services based on user-specific account credentials; and
authenticating the user for access to network services based on at least one parameter specific to at least one physical network component used to provide the network services to the user.

15. The invention recited in claim 14, wherein the at least one parameter includes a network access server (NAS) identifier (ID) used to deliver the network services to the user.

16. The invention recited in claim 14, wherein the at least one parameter includes a network access server (NAS) internet protocol (IP) address used to deliver the network services to the user.

17. The invention recited in claim 14, wherein the at least one parameter includes a description of a network access server (NAS) port used to deliver the network services to the user.

18. The invention recited in claim 14, wherein the at least one hardware-specific parameter includes an identifier (ID) of a network access server (NAS) used to deliver the network services to the user.

19. The invention recited in claim 14, wherein the network services include a plurality of bandwidth-intensive services.

20. The invention recited in claim 19, wherein the bandwidth-intensive services include at least two of streaming television, broadband Internet access and IP telephone.
